(19) United States
(12) Patent Application Publication
(10) Pub. No.: US 2011/0255001 A1
(43) Pub. Date: Oct. 20, 2011

(54) VIDEO SIGNAL PROCESSING DEVICE, VIDEO SIGNAL PROCESSING SYSTEM, AND VIDEO SIGNAL PROCESSING METHOD

(75) Inventor: Yuuki NISHIO, Kyoto (JP)

(73) Assignee: Panasonic Corporation, Osaka (JP)

(21) Appl. No.: 13/169,370

(22) Filed: Jun. 27, 2011

Related U.S. Application Data
(63) Continuation of application No. PCT/JP2009/003363, filed on Jul. 16, 2009.

(30) Foreign Application Priority Data
Feb. 2, 2009 (JP) 2009-021240

(51) Int. Cl. H04N 7/04

(52) U.S. Cl. 348/495; 348/469; 348/E07.04

(57) ABSTRACT

In a video signal processing device, a host CPU sets a number of parameters for a memory table at its low-load timing such as during power-up. The host CPU then enables the function of an automatic setting controller. Being notified of start of automatic setting, the automatic setting controller reads plural clock setting parameters from the memory table, and performs clock setting in a clock generation section while waiting for stabilization of PLL oscillation. The automatic setting control section then reads plural signal processing parameters from the memory table and sets the parameters in a video signal processing section. Thus, in operation of the video signal processing section and the clock generation section according to the format of the input video signal, it is possible to set a number of setting parameters in these sections while reducing the load of the host CPU, shortening the image output time.

### CROSS-REFERENCE TO RELATED APPLICATION

This is a continuation of PCT International Application PCT/JP2009/003363 filed on Jul. 16, 2009, which claims priority to Japanese Patent Application No. 2009-021240 filed on Feb. 2, 2009. The disclosures of these applications including the specifications, the drawings, and the claims are hereby incorporated by reference in their entirety.

### BACKGROUND

The present disclosure relates to a video signal processing device that transmits digital video/audio signals mainly and a method of automatic setting in the video processing.

Conventionally, a system that transmits images and voices for a DVD player/recorder, a digital video camera, etc. includes a host CPU and a video signal processing device connected to the host CPU via an I2C bus for serial transmission, for example, to operate according to a video signal format of the transmitted digital video/audio signal. The host CPU sends a number of setting parameters corresponding to the video signal format to the video signal processing device, and the video signal processing device performs transmission processing of the video/audio signal using the received setting parameters.

For example, in a high definition multimedia interface (HDMI) transmission system using HDMI, which is a standard for transmitting high definition images in the form of uncompressed digital data, a video/audio signal is received from a video signal source, for example. In order to encode the received video/audio signal into HDMI data and transmit the data, and in order to support DeepColor that expands the bit width of the video/audio data to be transmitted, etc., it is necessary for a clock generation section to generate a clock having a frequency 1.25 times or 1.5 times the video input clock. It is also necessary to generate data enable (DE) as a video control signal inside the HDMI transmission system when such a signal is not supplied from the video signal source. In such a case, to allow the HDMI transmission system to operate according to the input video signal format, the host CPU sends a number of setting parameters corresponding to the input video signal format to the HDMI transmission system via the I2C bus that is for serial transmission and has a rate as low as about 100 kbps to 400 kbps, for example, and performs setting of video signal processing parameters inside the HDMI transmission system and control of the operation of the clock generation section.

An example of the operation described above is shown in FIG. 10, which illustrates a flow of operation performed by the host CPU up to image output. First, as indicated by 200, the host CPU sets parameters for the clock generation section based on the video signal format of the video signal supplied from the video signal source. In general, although depending on the configuration of the clock generation section, the host CPU must perform setting of such parameters several tens of times repeatedly. As indicated by 201, when completing the clock setting, the host CPU starts a timer to wait for the lapse of a predetermined time, thereby to wait until a phase-locked loop (PLL) circuit in the clock generation section stabilizes the oscillation of a clock signal. As indicated by 202, after the lapse of the predetermined time, the host CPU performs setting of a number of video signal processing parameters for a video signal processing section repeatedly. As indicated by 203, when completing the setting, the host CPU instructs the video signal processing section to perform resetting. The series of operation is thus completed.

However, the conventional configuration described above has the following problem. Since the I2C bus is used for connection between the host CPU and the signal transmission system for reduction in the number of pins on the chip, the operation is slow and the host CPU must access the signal transmission system several tens of times repeatedly. This increases the processing time by the host CPU and complicates the processing, resulting in delay of image output.

To solve the problem described above, Japanese Patent Publication No. H11-52934 (page 11, FIG. 1) (Patent Document 1) describes a technique in which, when receiving a video/audio signal to be transmitted, the video signal processing device measures the received video/audio signal to ascertain the video signal format of this signal and detects a number of parameters according to the ascertained video signal format, thereby to perform automatic parameter setting without the necessity of setting of a number of parameters by the host CPU.

### SUMMARY

The technique in Patent Document 1 described above has the following drawbacks: the circuit scale increases because a signal measurement circuit and a parameter detection circuit are necessary; and this technique is not adaptable to transmission of a signal having a newly standardized video signal format.

For example, in video signal sources such as DVD players/recorders, video signal formats that are newly added, such as the “super high definition” 4K2K video format and the 3D video format allowing transmission of individual videos for the left and right halves of the screen, are to be standardized in the future. In the signal transmission system in Patent Document 1, however, in the case that a video signal source that stores a video/audio signal having a newly standardized video signal format is included in the signal transmission system together with the host CPU to constitute set equipment, the signal measurement circuit and the parameter detection circuit of the video signal processing device will fail to recognize the newly standardized video signal format even if the video/audio signal having the newly standardized video signal format is input into the video signal processing device.

In view of the problem described above, it is an objective of the present disclosure to provide a video signal processing device that can decrease the number of times of setting from the host CPU and is easily adaptable to addition of a newly standardized video signal format, to allow a number of parameters corresponding to the newly standardized video signal format to be set in its signal processing section, etc. smoothly.

To attain the above objective, a video signal processing device according to the present disclosure additionally includes a storage section that stores a number of parameters received from the host CPU, and also includes an automatic parameter setting section that sets a number of parameters stored in the storage section in a signal processing section and a clock generation section.

Specifically, the video signal processing device of the present disclosure is a video signal processing device including a signal processing section configured to receive a video signal from a video signal source and perform predetermined processing for the received video signal, the device including: a memory section configured to store a plurality of parameters required to perform the predetermined processing according to a video signal format of the received video signal; and an automatic parameter setting section configured to read the plurality of parameters stored in the memory section and set the parameters in the signal processing section.

The video signal processing device described above may further include a clock generation section configured to generate a clock signal corresponding to the video signal format of the received video signal, wherein the memory section also stores a plurality of parameters required to generate the clock signal corresponding to the video signal format of the received video signal, and the automatic parameter setting section reads the plurality of parameters for clock signal generation stored in the memory section and sets the parameters in the clock generation section.

In the video signal processing device described above, the signal processing section may perform the predetermined processing for a video signal received according to HDMI standard.

A video signal processing system of the present disclosure includes: the video signal processing device described above; and a host CPU connected to the video signal processing device, configured to output the plurality of parameters to be stored in the memory section of the video signal processing device.

In the video signal processing system described above, the video signal processing device and the host CPU may be connected via a serial bus.

In the video signal processing system described above, the host CPU may output the plurality of parameters to be stored in the memory section when the load of the host CPU is small.

In the video signal processing system described above, the time when the load of the host CPU is small may be during power-up.

In the video signal processing system described above, after outputting the plurality of parameters to be stored in the memory section, the host CPU may instruct the automatic parameter setting section to start automatic setting of parameters.

In the video signal processing device described above, the memory section may include a nonvolatile memory.

In the video signal processing device described above, the memory section may include one memory table.

In the video signal processing device described above, the memory section may include a plurality of memory tables.

In the video signal processing system described above, all addresses in the memory section may be mapped to address space of the host CPU used at the time of write of parameters into the memory section.

In the video signal processing system described above, the memory section may include a plurality of memory tables, and addresses of one table, among the plurality of memory tables, may be mapped to address space of the host CPU used at the time of write of parameters into the memory section.

In the video signal processing system described above, the host CPU can set the parameters directly in the signal processing section without use of the automatic parameter setting section, and address space of the host CPU used at the direct setting of the parameters in the signal processing section may be shared as address space of the host CPU used at the time of write of parameters into the memory section.

In the video signal processing device described above, the memory section may have a fixed parameter table that holds parameters for a video signal format of the received video signal when the video signal format is an existing format.

In the video signal processing device described above, whether parameters to be set in the signal processing section should be stored in the fixed parameter table or in a region other than the fixed parameter table may be determined.

In the video signal processing device described above, when video signals of a plurality of types of video signal formats are stored in the video signal source, a parameter value common among parameters corresponding to the plurality of types of video signal formats may be stored in the fixed parameter table.

In the video signal processing device described above, a plurality of parameter values stored in the fixed parameter table may be read, only some of the plurality of read parameter values may be changed to another value, and all the parameters including the changed parameter may be stored in a region of the memory section other than the fixed parameter table.

A video signal processing method of the present disclosure includes the steps of: after receiving a video signal from a video signal source, reading a plurality of parameters required to perform predetermined processing according to a video signal format of the video signal; and setting the plurality of read parameters in a signal processing section configured to perform the predetermined processing.

Thus, according to the present disclosure, the automatic parameter setting section reads various types of parameters from the memory section and automatically sets the parameters in the signal processing section. This decreases the number of times of setting of parameters from the host CPU that is connected to the video signal processing device as part of set equipment. As a result, the load of the host CPU is reduced, and the time required until image output is effectively shortened.

Also, since the memory section for storing parameters is provided, a number of parameters corresponding to a newly standardized video signal format can be stored in the memory section from the host CPU in an ex post facto manner. Therefore, good image output is also possible for a video signal having a newly standardized video signal format.

As described above, according to the present disclosure, the load of the host CPU during image output can be reduced, and the time required to output an image via HDMI, for example, can be shortened.

Also, the automatic setting function is available also for a newly added video signal format of a video/audio signal.

### BRIEF DESCRIPTION OF THE DRAWINGS

FIG. 1 is a view showing an example of the entire configuration of an HDMI transmission system including a video signal processing device of the first embodiment of the present disclosure.

FIG. 2 is a view illustrating a procedure of setting of a number of parameters performed by a host CPU of the HDMI transmission system.

FIG. 3 is a view showing an example configuration of a main portion of a video signal processing device of the second embodiment of the present disclosure.

FIG. 4 is a view showing a configuration in a video signal processing device of the third embodiment of the present invention, in which the entire regions of memory tables are mapped to the address space of the host CPU.

FIG. 5 is a view showing a configuration in a video signal processing device of the fourth embodiment of the present invention, in which the region of only one memory table is mapped to the address space of the host CPU.

FIG. 6 is a view showing a configuration in a video signal processing device of the fifth embodiment of the present invention, in which manual setting addresses and addresses of a memory table share the address space of the host CPU.

FIG. 7 is a view showing a video signal processing device of the sixth embodiment of the present disclosure.

FIG. 8 is a view showing a video signal processing device of the seventh embodiment of the present disclosure.

FIG. 9 is a view illustrating a method of reading values from a fixed table and writing corrected values into a memory table.

FIG. 10 is a view illustrating a procedure of setting of a number of parameters performed by the conventional host CPU.

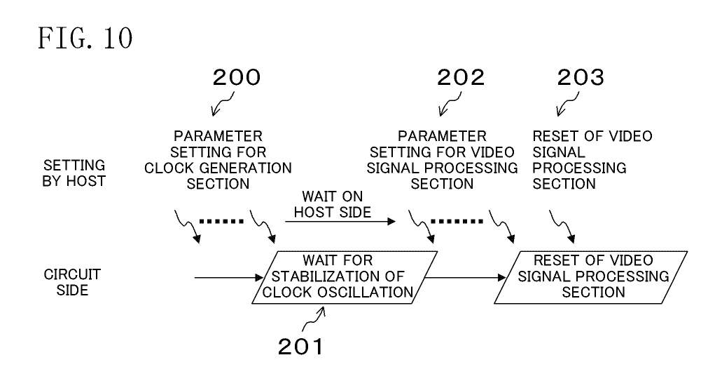

### DETAILED DESCRIPTION

Embodiments of the present disclosure will be described hereinafter with reference to the accompanying drawings.

Although an HDMI transmission system is used as an example in the following description of the embodiments, the present disclosure is not especially limited to the HDMI transmission system.

### First Embodiment

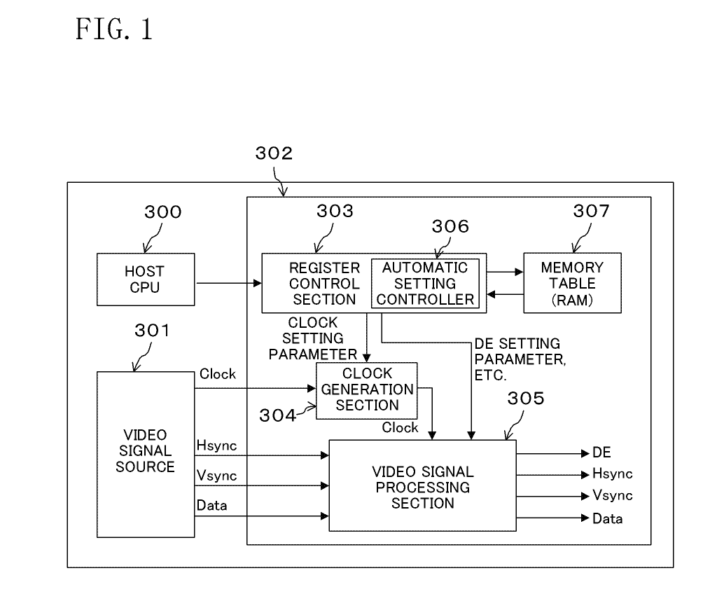

FIG. 1 shows an HDMI transmission system having a video signal processing device of the first embodiment of the present disclosure.

Referring to FIG. 1, a host CPU 300, a video signal source 301, and a video signal processing device 302 are combined together as set equipment to constitute an HDMI signal transmission system (video signal processing system) as a whole.

The video signal processing device 302 includes a register control section 303, a clock generation section 304, and a video signal processing section (signal processing section) 305. The register control section 303 includes an automatic setting controller 306 that is essential for the present disclosure, and a memory table 307 is connected to the register control section 303.

In order to process a video/audio signal supplied from the video signal source 301 according to its video signal format, the clock generation section 304 and the video signal processing section 305 need a number of parameters corresponding to the video signal format. Such a number of parameters, including data enable (DE) that is a video control signal, are previously stored in the memory table (memory section) 307 by the host CPU 300 via the register control section 303. During image output, the automatic setting controller (automatic parameter setting section) 306 acquires setting parameters from the memory table 307 and sets the acquired parameters in the clock generation section 304 and the video signal processing section 305, and also waits for stabilization of oscillation of a clock signal in a PLL circuit (not shown) of the clock generation section 304.

The host CPU 300 previously knows information on various types of video/audio signals (video/audio data Data, a horizontal synchronizing signal Hsync, a vertical synchronizing signal Vsync, and a clock signal Clock) stored in the video signal source 301 from the specifications/waveform observation of the signals. The host CPU 300 also knows the video signal format of the video/audio signal input into the video signal processing device 302, and knows a number of parameters corresponding to the video signal format.

Although the video signal source 301 is used to constitute the set equipment together with the video signal processing device 302 in FIG. 1, the video signal processing device 302 can also be incorporated to constitute different types of set equipment together with DVD players/recorders, digital cameras, etc.

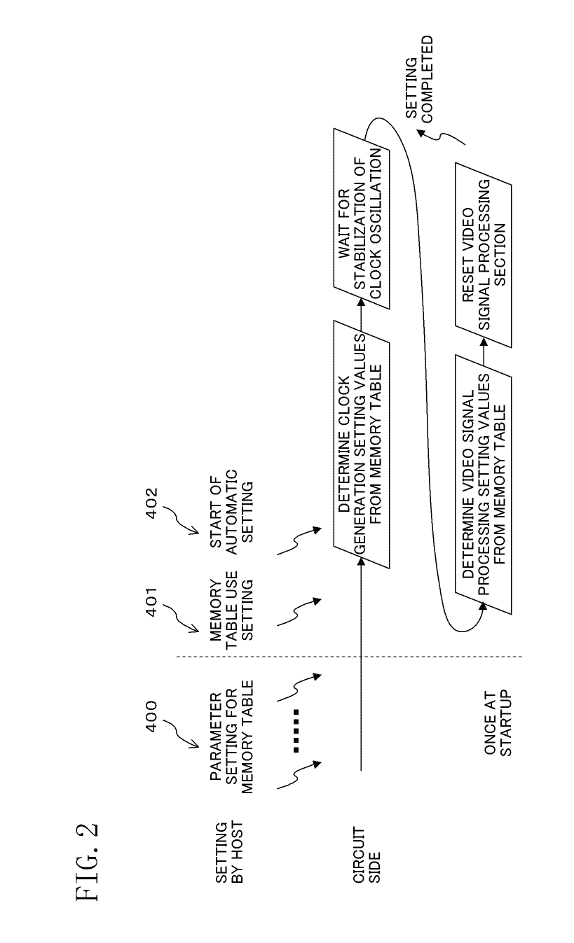

FIG. 2 shows an operation performed by the host CPU 300 up to image output. Referring to FIG. 2, first, the host CPU 300 performs setting 400 of parameters for the memory table 307 at the time of initialization of the set equipment such as during power-up. Note that, although described as during power-up in this embodiment, the time of setting of parameters is not specifically limited. It is only essential to write parameters into the memory table 307 at any convenient timing, such as timing at which the host CPU 300 of the set equipment (i.e., the HDMI signal transmission system) is less loaded, before the image output is done.

The memory table 307 may be constituted by a RAM, a flipflop, etc., for example, but the type of the memory element is not limited.

After the power-up, the host CPU 300 performs memory table use setting 401 for the register control section 303, to enable the function of the automatic setting controller 306, and then notifies the automatic setting controller 306 of start of automatic setting 402, to allow the automatic setting controller 306 to read previously-stored clock setting parameters from the storage table 307 and perform clock setting for the clock generation section 304.

When the clock setting is terminated, the automatic setting controller 306 starts a timer for waiting for stabilization of oscillation of the PLL circuit (not shown) of the clock generation section 304. After the lapse of a predetermined time, the automatic setting controller 306 reads signal processing parameters for the video signal processing section 305 from the storage table 307 and sets the parameters in the video signal processing section 305.

When the parameter setting in the video signal processing section 305 is terminated, the automatic setting controller 306 resets the video signal processing section 305, whereby the setting is completed.

Once the entire setting is completed as described above, the host CPU 300 knows the completion of the entire setting by receiving an interrupt issued by the automatic setting controller 306 or by polling the automatic setting controller 306.

In the series of operation described above, the number of times of access to the resister control section 303 by the host CPU 300 is only two, excluding the operation of setting of parameters for the memory table 307. This greatly shortens the processing time by the host CPU 300 compared to the conventional case where several tens of times of access are necessary. Moreover, after the power-up, i.e., after the setting of a number of parameters for the memory table 307, video/audio signals having different video signal formats are read from the video signal source 301 at random, causing dynamic changes from one video signal format to another. At each of such changes of the video signal format, the host CPU 300 needs only two times of access to the register control section 303. Therefore, since the host CPU 300 does not need to repeat access to the register control section 303 several tens of times at each of such changes, unlike the conventional case, the processing time by the host CPU 300 is further shortened.

When the memory table 307 is constituted by a nonvolatile memory (of whatever type, such as a flash memory), once-stored parameter values are held even after power is turned off. Therefore, in the case of using a fixed video signal format, once parameters are written, it is no more necessary to write the parameters again during power-up, for example. Thus, the host CPU 300 is further less loaded.

### Second Embodiment

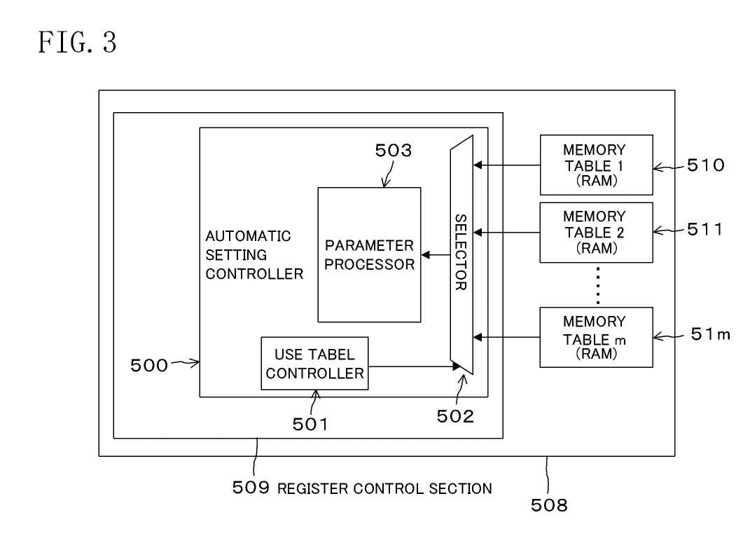

FIG. 3 shows the second embodiment of the present disclosure.

Referring to FIG. 3, in a video signal processing device 508, an automatic setting controller 500 includes a use table controller 501 and a selector 502 as additional components, and m memory tables 510 to 51m are prepared.

The host CPU notifies the use table controller 501 of the automatic setting controller 500, which is in a register control section 509, of the table to be used. According to this notification, the use table controller 501 controls the selector 502 to select, as the input, a memory table, among the memory tables 510 to 51m in which parameters are previously written, which stores parameters corresponding to the video signal format currently being input. The parameters from the selected memory table are sent to a parameter processor 503, and then set in the clock generation section and the video signal processing section at appropriate timing.

When there is only one memory table, the memory table must be rewritten every time the video signal format is changed. In this embodiment, however, which has multiple memory tables 510 to 51m, it is unnecessary to rewrite parameters for a video signal format frequently used, and thus eliminates the necessity of frequent setting of parameters for the memory tables 510 to 51m.

Several types of video/audio signals having newly standardized video signal formats may be additionally stored in the video signal source. In such a case, while keeping parameters corresponding to an existing video signal format stored in some memory table, it is possible to store parameters corresponding to the newly standardized video signal formats in the other memory tables. This configuration is therefore very useful.

### Third Embodiment

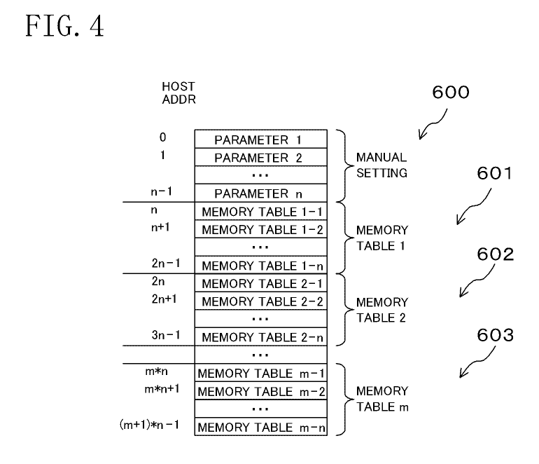

FIG. 4 shows the third embodiment of the present disclosure.

FIG. 4 illustrates a method adopted when parameters are previously written in memory tables provided in a video signal processing device, showing an example method of mapping the entire m memory tables to the host address space. This embodiment is also applicable to the case of using only one memory table by setting m=1.

Assuming that there are n parameters of addresses 0 to n−1 in a register region used when the host CPU sets parameters directly in the clock generation section 304 and the video signal processing section 305 as in the conventional case (this setting is hereinafter referred to as “manual setting” as compared to automatic setting of parameters by the automatic setting controller 306 according to the present disclosure), i.e., a manual setting register region 600, the address of parameter 1 in a register region 601 for memory table 1 is n, and the address of parameter n in this register region is 2n−1. Likewise, the address of parameter 1 in a register region 602 for memory table 2 is 2n, and the address of parameter n in this register region is 3n−1. That is, the address of parameter 1 in a register region 603 for memory table m is m×n, and the address of parameter n in this register region is (m+1)×n−1.

The above method is useful when the host address space has room to spare because the structure is simple. Parameters written in the memory tables can be easily read out.

### Fourth Embodiment

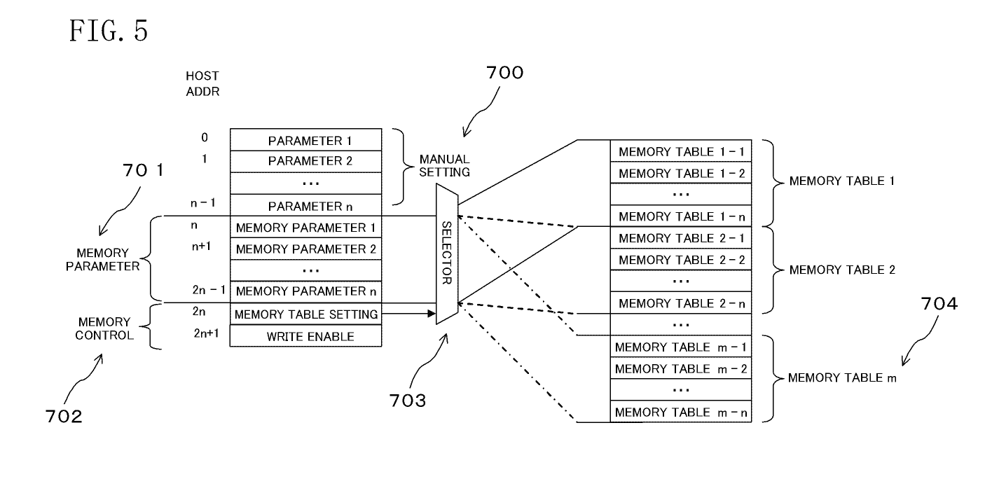

FIG. 5 shows the fourth embodiment of the present disclosure.

FIG. 5 illustrates a method adopted when parameters are previously written in memory tables provided in a video signal processing device, showing an example method of mapping only one memory table to the host address space.

Assuming that there are n parameters of addresses 0 to n−1 in a manual setting register region 700, the address of parameter 1 in a memory parameter register region 701 is n, and the address of parameter n in this register region is 2n−1.

Also, in a memory control register region 702, address 2n is used for memory table setting and address 2n+1 for write enable.

In the case of write into memory table m, parameters of which write is desired are written into the memory parameter register region 701 from the host CPU. Thereafter, in the register region 702, the memory table is set at “m” at address 2n, and write enable is set at address 2n+1. By this setting, a selector 703 selects the memory table m 704, to allow the values written in the memory parameter register region 701 to be written into the memory table m (704).

The above method is useful when the host address space has no room to spare.

### Fifth Embodiment

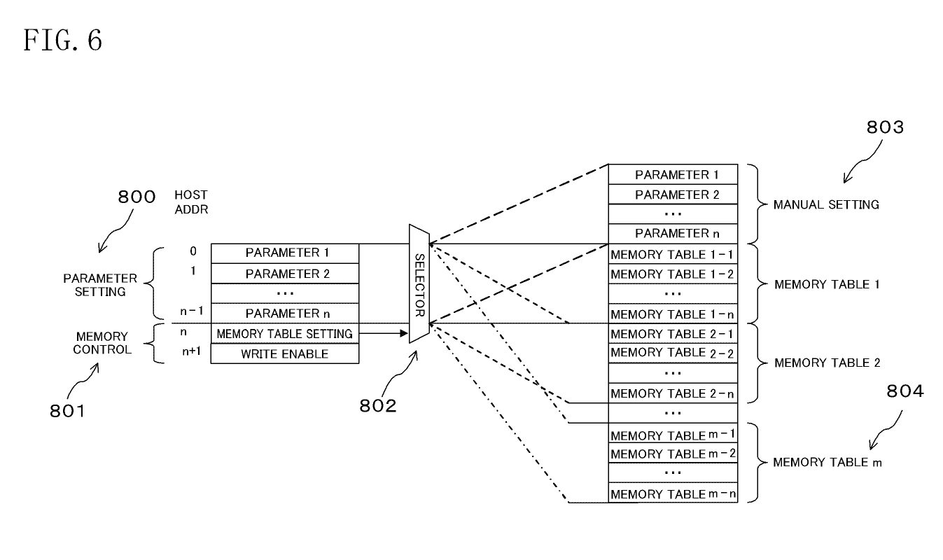

FIG. 6 shows the fifth embodiment of the present disclosure.

FIG. 6 illustrates a method adopted when parameters are previously written in memory tables provided in a video signal processing device, showing an example method of sharing the host address space by a manual setting region and a memory region.

Referring to FIG. 6, n parameters of addresses 0 to n−1 are mapped to a parameter setting register region 800. Also, a memory control register region 801 is prepared.

During normal use, by setting the memory table at “0,” indicating manual setting, in the memory control register region 801, the selector 802 selects a manual setting region 803 for use.

In the case of write of memory table m, parameters of which write is desired are written into the parameter setting register region 800 from the host CPU. Thereafter, in the memory control register region 801, the memory table is set at “m” at address n, and write enable is set at address n+1. By this setting, the selector 802 selects the memory table m 804, to allow the parameter values written in the parameter setting register region 800 to be written into the memory table m 804.

The above method is useful when the host address space has no room to spare at all.

### Sixth Embodiment

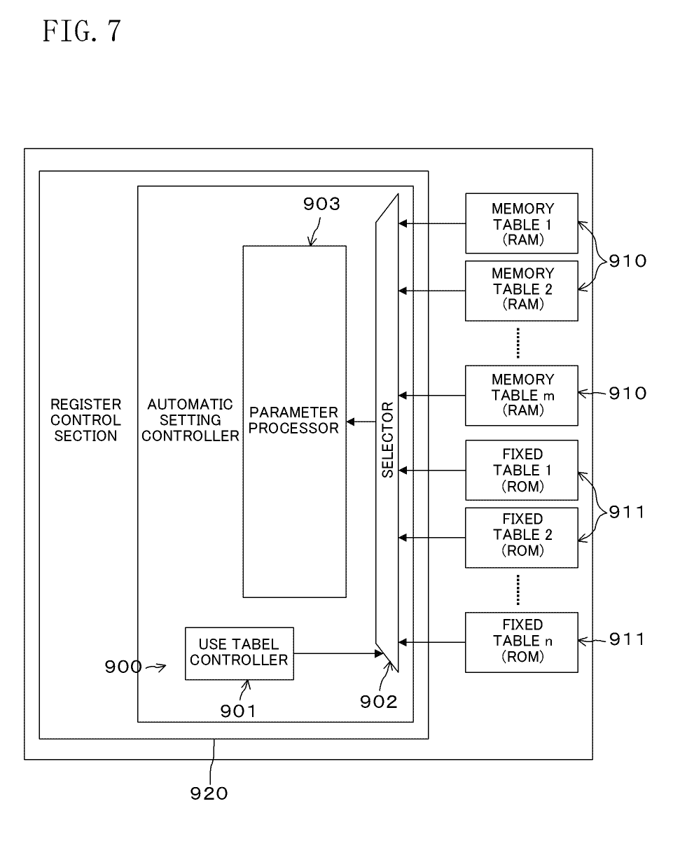

FIG. 7 shows the sixth embodiment of the present disclosure.

Referring to FIG. 7, an automatic setting controller 900 of a register control section 920 includes a use table controller 901 and a selector 902, and fixed tables 911 are prepared in addition to memory tables 910. The fixed tables 911 are non-rewritable tables constituted by a ROM, a wired logic, etc. Parameter values for a known video signal format can be previously written in a fixed table.

Operation at the time of use of a newly-added video signal format will be described. Assume herein that, when a video/audio signal having a newly-added video signal format is stored in the video signal source, parameters for such a newly-added video signal format are written in memory table m 910.

Under an instruction from the host CPU, the use table controller 901 controls the selector 902 to select the memory table m 910. Thus, the parameters written in the memory table m 910 are read to a parameter processor 903, to permit automatic setting of the clock generation section and the video signal processing section according to the newly-added video signal format.

Next, operation at the time of use of an existing video signal format will be described. Assume herein that parameters for the existing video signal format are written in fixed table n 911. Under an instruction from the host CPU, the use table controller 901 controls the selector 902 to select the fixed table n 911. Thus, the parameters written in the fixed table n 911 are read to the parameter processor 903, to permit automatic setting of the clock generation section and the video signal processing section according to the existing video signal format.

In this embodiment, since the fixed tables 911 are provided in which parameters for existing video signal formats are stored, it is unnecessary to perform initial setting of such parameters from the host CPU during power-up, permitting further reduction in the load of the host CPU.

Also, since the fixed tables 911 are small circuits compared to memory elements such as RAMs, further reduction in the load of the host CPU and reduction in circuit scale can be achieved.

### Seventh Embodiment

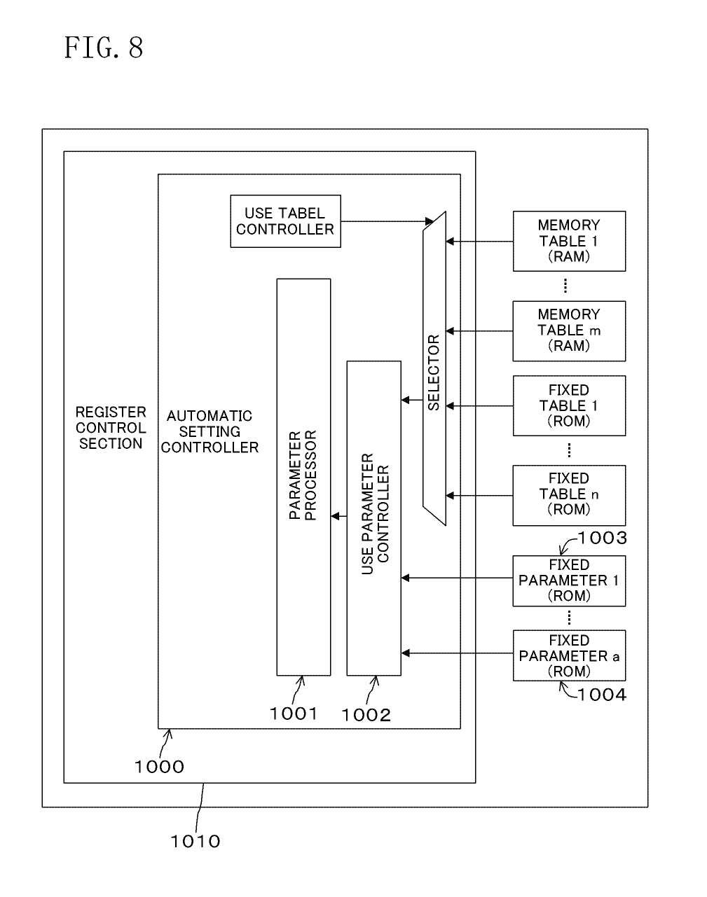

FIG. 8 shows the seventh embodiment of the present disclosure.

Referring to FIG. 8, an automatic setting controller 1000 of a register control section 1010 includes a use parameter controller 1002, and fixed parameters 1 (1003) to a (1004) are prepared.

The fixed parameters 1 to a are non-rewritable parameters stored in ROM, wired logic, etc. Parameter values common to all video signal formats and parameter values common to some video signal formats are stored in the fixed parameters 1 to a.

Operation at the time of use of the fixed parameters 1 to a will be described. The use parameter controller 1002 is previously configured to use the fixed parameter 1 1003 when parameter x is called from a parameter processor 1001 and use the fixed parameter a 1004 when parameter y is called from the parameter processor 1001.

A method of reading the fixed parameter 1 1003 in an automatic setting sequence will be described as an example.

During operation of the automatic setting sequence, when the parameter processor 1001 issues a request for read from the fixed parameter 1 1003, the use parameter controller 1002, interpreting this request as a request for read of parameter x, reads the value of the fixed parameter 1 1003 and transfers the value to the parameter processor 1001, to complete the processing.

In this embodiment, with the fixed parameters 1 to a provided, the sizes of the memory tables and fixed tables themselves can be reduced. Also, since part of the initial setting from the host CPU can be omitted, the load of the host CPU can be reduced.

Although m memory tables and n fixed tables are provided in this embodiment, m and n are variable values, and are not limited to specific values. This embodiment is also applicable to a configuration having no fixed table.

### Eighth Embodiment

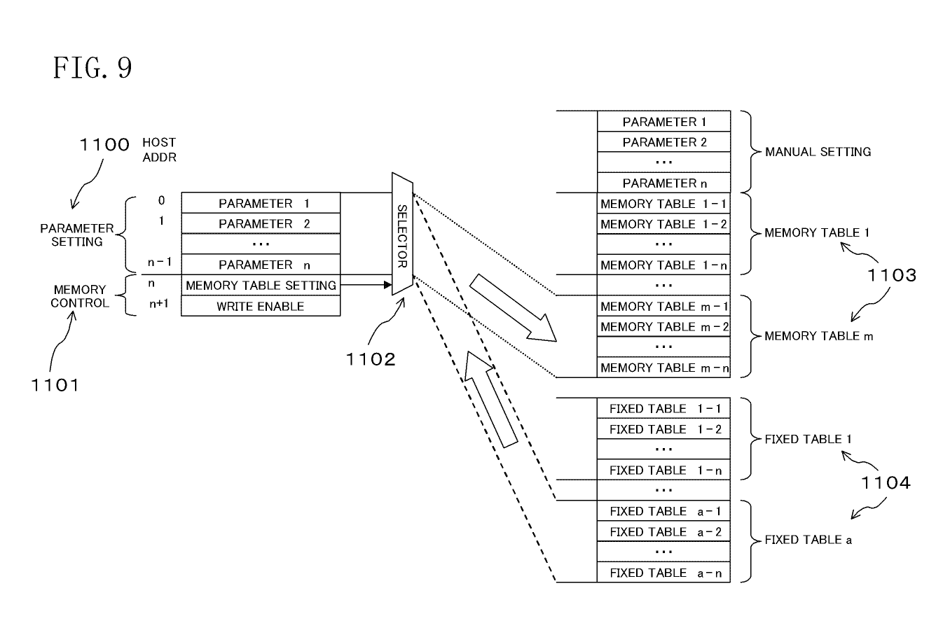

FIG. 9 shows the eighth embodiment of the present disclosure.

FIG. 9 shows an example method in which parameters in fixed table a 1104 are called, only some of the called parameters are rewritten, and then all the parameters including the rewritten parameter(s) are written into memory table m 1103. The combination of the fixed table and the memory table to be read from and written into is not specifically limited, but an arbitrary combination may be used.

Referring to FIG. 9, first, a memory control register region 1101 is set so that a selector 1102 selects the fixed table a 1104, to allow parameter values in the fixed table a 1104 to be read into a parameter setting register region 1100.

After completion of the readout, assuming that parameters n−1 and n at host addresses n−2 and n−1, for example, are to be changed to desired values, the host CPU first changes the parameter n−1 at host address n−2 to a desired value, and then changes the parameter n at host address n−1 to a desired value.

After completion of rewrite of parameters of which change is required, the memory control register region 1101 is set so that the selector 1102 selects the memory table m 1103, to allow all the parameters including the changed parameters to be written into the memory table m 1103.

By adopting the above method, when a newly-added video signal format is close in parameter values to an existing video signal format in any of the fixed tables 1 to a (1104), the number of times by which the host CPU writes parameter values into the memory table m 1103 can be reduced. Thus, the load of the host CPU can be further reduced.

As described above, according to the present disclosure, the video signal processing device with a simple circuit configuration can set automatically necessary parameters for even video signal formats to be newly added in the future, such as the super HD video format and the 3D video format, in the signal processing section and the clock generation section. Therefore, the present disclosure is useful as a video signal processing device that can reduce the load of the host CPU in the same set equipment and resultantly can shorten the image output time.

What is claimed is:

1. A video signal processing device comprising a signal processing section configured to receive a video signal from a video signal source and perform predetermined processing for the received video signal, the device comprising:
a memory section configured to store a plurality of parameters required to perform the predetermined processing according to a video signal format of the received video signal; and
an automatic parameter setting section configured to read the plurality of parameters stored in the memory section and set the parameters in the signal processing section.

2. The device of claim 1, further comprising:
a clock generation section configured to generate a clock signal corresponding to the video signal format of the received video signal,
wherein
the memory section also stores a plurality of parameters required to generate the clock signal corresponding to the video signal format of the received video signal, and
the automatic parameter setting section reads the plurality of parameters for clock signal generation stored in the memory section and sets the parameters in the clock generation section.

3. The device of claim 1, wherein
the signal processing section performs the predetermined processing for a video signal received according to HDMI standard.

4. A video signal processing system, comprising:
the video signal processing device of claim 1; and
a host CPU connected to the video signal processing device, configured to output the plurality of parameters to be stored in the memory section of the video signal processing device.

5. The system of claim 4, wherein
the video signal processing device and the host CPU are connected via a serial bus.

6. The system of claim 4, wherein
the host CPU outputs the plurality of parameters to be stored in the memory section when the load of the host CPU is small.

7. The system of claim 6, wherein
the time when the load of the host CPU is small is during power-up.

8. The system of claim 6, wherein
after outputting the plurality of parameters to be stored in the memory section, the host CPU instructs the automatic parameter setting section to start automatic setting of parameters.

9. The device of claim 1, wherein
the memory section includes a nonvolatile memory.

10. The device of claim 1, wherein
the memory section includes one memory table.

11. The device of claim 1, wherein
the memory section includes a plurality of memory tables.

12. The system of claim 4, wherein
all addresses in the memory section are mapped to address space of the host CPU used at the time of write of parameters into the memory section.

13. The system of claim 4, wherein
the memory section includes a plurality of memory tables, and
addresses of one table, among the plurality of memory tables, are mapped to address space of the host CPU used at the time of write of parameters into the memory section.

14. The system of claim 4, wherein
the host CPU can set the parameters directly in the signal processing section without use of the automatic parameter setting section, and
address space of the host CPU used at the direct setting of the parameters in the signal processing section is shared as address space of the host CPU used at the time of write of parameters into the memory section.

15. The device of claim 1, wherein
the memory section has a fixed parameter table that holds parameters for a video signal format of the received video signal when the video signal format is an existing format.

16. The device of claim 15, wherein
whether parameters to be set in the signal processing section should be stored in the fixed parameter table or in a region other than the fixed parameter table is determined.

17. The device of claim 15, wherein
when video signals of a plurality of types of video signal formats are stored in the video signal source, a parameter value common among parameters corresponding to the plurality of types of video signal formats is stored in the fixed parameter table.

18. The device of claim 15, wherein
a plurality of parameter values stored in the fixed parameter table are read, only some of the plurality of read parameter values is changed to another value, and all the parameters including the changed parameter are stored in a region of the memory section other than the fixed parameter table.

19. A video signal processing method, comprising the steps of:
after receiving a video signal from a video signal source,
reading a plurality of parameters required to perform predetermined processing according to a video signal format of the video signal; and
setting the plurality of read parameters in a signal processing section configured to perform the predetermined processing.
